(19) United States
(12) Patent Application Publication
(10) Pub. No.: US 2017/0070044 A1
(43) Pub. Date: Mar. 9, 2017

(54) ROBUST RESTORATION METHOD FOR ACTIVE DISTRIBUTION NETWORK

(71) Applicant: Tsinghua University, Beijing (CN)

(72) Inventors: WENCHUAN WU, Beijing (CN); BOMING ZHANG, Beijing (CN); HONGBIN SUN, Beijing (CN); XIN CHEN, Beijing (CN); QINGLAI GUO, Beijing (CN); BIN WANG, Beijing (CN)

(21) Appl. No.: 14/957,666

(22) Filed: Dec. 3, 2015

(30) Foreign Application Priority Data
Sep. 6, 2015 (CN) 201510559469.3

(51) Int. Cl. H02H 7/26; H02J 3/00; G05B 13/04

(52) U.S. Cl. CPC H02H 7/26; G05B 13/041; H02J 3/00

(57) ABSTRACT

The present disclosure provides a robust restoration method for an active distribution network, which can be used under uncertain environment. For uncertain factors in the power restoration, the robust restoration method creates polyhedral uncertainty sets of the load demands and the distribution generation outputs and presents a two-stage robust restoration optimization model to obtain switching decisions under the worst-case fluctuation scenarios, thereby maximizing the restored power, while satisfying constraints and uncertainty budget. The robust restoration method uses the column-and-constraint generation algorithm to solve the robust restoration optimization model. The robust restoration strategies generated by the model can make sure restoration feasibility under any fluctuation scenarios in the uncertainty sets. Implementation of the method is simple and the method has practicability and can solve unfeasibility of restoration strategies caused by uncertain factors in the active distribution network.

### CROSS-REFERENCE TO RELATED APPLICATION

This application claims priority to and benefits of Chinese Patent Application Serial No. 201510559469.3, filed with the State Intellectual Property Office of P. R. China on Sep. 6, 2015, the entire contents of which are incorporated herein by reference.

### FIELD

The present disclosure relates to optimal operation control of power system, more particularly, to a robust restoration method for an active distribution network, which can be used under uncertain environment.

### BACKGROUND

In recent years, distributed generations (DG) have increased markedly in distribution networks, and these comprise photovoltaic and wind power generators, which are the main contributors to active distribution networks (ADN), but also present a series of threats to consistent power supply. For restoration of the distributed generation, the service restoration is a time-consuming process because a lots of switches and equipment need to be manually operated. During the service restoration period, the DG outputs fluctuate due to weather and environment and become unstable. Meanwhile, time-varying load demands in the connected area contribute further uncertainties to the service restoration period. Besides, because of the low level of automation in the distribution network, few the real-time measurements exist. The measured load demands from most non-metric measurement buses are obtained by a load-curve method or a short-term load forecasting method. These measured load demands obtained above may be deviated from the real load demands and it is different to obtain a high-quality and reliable estimation of all load demands. Therefore, in real word, fluctuating DG outputs, time-varying load demands and estimation errors of loads are three major sources of uncertainty factors in ADN restoration.

Switches in the ADN include normally-closed section switches and normally-open contact switches. After detection and isolation of faults, the topology structure of the distribution network needs to be reconfigured to restore power to the outage area through changing the status of switches. Therefore, restoration control is essentially to meet the optimal combination of open-and-closed switches in the operation constraints of ADN. Fulfilling the open-and-closed scheme of the specific switches is against restoration control strategy of one fault. The conventional certainty restoration control method does not consider the fluctuating DG outputs and time-varying load demands. In practice, the restoration result from the strategy generated by the certainty restoration control method may be poor, and branches overloading or voltage violations may occur under some open-and-closed schemes of the switches. This can result in unfeasibility of the restoration control strategy. Such un-robust restoration scheme may cause additional customers' outage. Therefore, this range of uncertainties present significant challenges to conventional deterministic algorithms in ADN, and a more robust restoration technique is required to ensure the feasibility and reliability of restoration strategies.

### SUMMARY

In our implementation, a robust restoration method for an active distribution network includes steps of:

1) after detection and isolation of faults in the active distribution network, creating polyhedral uncertainty sets II according to historical data, current load demands and distribution generation outputs of the active distribution network, wherein

$$Π = \{ \begin{matrix}{\tilde{P}}_{i} ∈ [ {P}_{i}^{0} - \underline{{\hat{P}}_{i}} , {P}_{i}^{0} + \overline{{\hat{P}}_{i}} ] , ∀ i ∈ {Ψ}_{con} \\ {\tilde{P}}_{i}^{dg} ∈ [ {P}_{i}^{0 , dg} - {\underline{{\hat{P}}_{i}}}^{dg} , {P}_{i}^{0 , dg} + {\overline{\hat{P}}}_{i}^{dg} ] , ∀ i ∈ {Ψ}_{dg}\end{matrix} , \qquad ( 1 )$$

Ψ_{con} is set of buses in a connected area of the active distribution network, for each load demand bus i belonging to Ψ_{con} in the connected area, \tilde{P}ᵢ is actual active load demand at the load demand bus i during a restoration period, Pᵢ⁰ is known current active load demand at the load demand bus i, \hat{P}ᵢ and \hat{P̅}ᵢ are the lower limit and the upper limit of active load demand at the load demand bus i during the restoration period and range from [0, 0.5Pᵢ⁰] respectively; Ψ_{dg} is set of buses connected with distributed generations in the active distribution network; for each distribution generation bus i belonging to Ψ_{dg}, \tilde{P}ᵢ^{dg} is actual active distribution generation output at the distribution generation bus i during the restoration period, Pᵢ^{0,dg} is known current active distribution generation output at the distribution generation bus i, \hat{P}ᵢ^{dg} and \hat{P̅}ᵢ^{dg} are the lower limit and the upper limit of active distribution generation output at the distribution generation bus i and range from [0, 0.5Pᵢ^{0,dg}] respectively;

2) presenting formulation of a two-stage robust restoration optimization model as following:

$${Max}_{z ∈ Ω} [ {Min}_{p ∈ Π} ( Max {\sum }_{i ∈ {Ψ}_{out}} {\tilde{P}}_{i} ) ] , \qquad ( 2 )$$

wherein, Ψₒᵤₜ is set of buses in an outage area of the active distribution network; p is a vector of uncertain variables subject to the uncertainty sets II, involving uncertain distribution generation outputs of \tilde{P}ᵢ^{dg} and uncertain load demands of \tilde{P}ᵢ, and order of elements in the vector p ascends according to the number of the bus i; z is a vector of switching decisions in each branch of the active distribution network, and each element in the vector z is equal to zero or one, the element being equal to zero indicates a corresponding branch switch is open, the element being equal to one indicates the corresponding branch switch is closed; Ω denotes feasible region of the vector z;

$$Max {\sum }_{i ∈ {Ψ}_{out}} {\tilde{P}}_{i}$$

represents maximizing the restored power in the outage area,

$${Min}_{p ∈ Π}$$

( ) represents searching for the worst-case fluctuation scenarios across the uncertainty sets Π with the vector p regarded as decision variables to restore as much outage load as possible;

$${Max}_{z ∈ Ω}$$

[ ] represents generating optimal restoration strategies in the worst-case fluctuation scenarios with the vector z regarded as decision variables to maximize the restored power;

3) setting radial topology structure operation constraint of the active distribution network as following:

$$\{ \begin{matrix}{\sum }_{( ij ) ∈ {Φ}_{i}} {z}_{ij} = {n}_{b} - {n}_{s} \\ {z}_{ij} ∈ \{ 0 , 1 \} , ∀ ( ij ) ∈ {Φ}_{l}\end{matrix} , \qquad ( 3 )$$

wherein, Φₗ is set of all branches in the active distribution network after isolation of the faults; for each branch ij belonging to Φₗ, zᵢⱼ is a binary status variable representing the status of branch ij, zᵢⱼ being equal to zero indicates the branch is disconnected, zᵢⱼ being equal to one indicates the branch is connected; n_{b} is the number of all buses in the active distribution network after isolation of the faults and is a known value; nₛ is the number of substation buses in the active distribution network after isolation of the faults and is a known value;

4) setting branch capacity constraint for each branch in the active distribution network as following:

$$\{ \begin{matrix}- {z}_{ij} \cdot {\overline{s}}_{ij} \leq {p}_{ij} \leq {z}_{ij} \cdot {\overline{s}}_{ij} \\ - {z}_{ij} \cdot {\overline{s}}_{ij} \leq {q}_{ij} \leq {z}_{ij} \cdot {\overline{s}}_{ij} \\ - \sqrt{2} {z}_{ij} \cdot {\overline{s}}_{ij} \leq {p}_{ij} + {q}_{ij} \leq \sqrt{2} {z}_{ij} \cdot {\overline{s}}_{ij} \\ - \sqrt{2} {z}_{ij} \cdot {\overline{s}}_{ij} \leq {p}_{ij} - {q}_{ij} \leq \sqrt{2} {z}_{ij} \cdot {\overline{s}}_{ij} \\ ∀ ( ij ) ∈ {Φ}_{l}\end{matrix} , \qquad ( 4 )$$

wherein, for each branch ij belonging to Φₗ, pᵢⱼ is active power flow from bus i to bus j; qᵢⱼ is reactive power flow from bus i to bus j; s̅ᵢⱼ is apparent power capacity of branch ij;

5) setting voltage security constraint for each bus in the active distribution network as following:

$$\{ \begin{matrix}{U}_{i} = {V}_{i}^{2} \\ {\underline{U}}_{i} \leq {U}_{i} \leq {\overline{U}}_{i} , ∀ i ∈ {Ψ}_{b}\end{matrix} , \qquad ( 5 )$$

wherein, Ψ_{b} is set of all buses in the active distribution network after isolation of the faults; for each bus i belonging to Ψ_{b}, Vᵢ is voltage magnitude at bus i; Uᵢ is squared voltage magnitude representing voltage variable; Uᵢ and Ūᵢ are the lower limit and the upper limit of the squared voltage magnitude at bus i, respectively;

6) setting power flow equality constraint for each branch in the active distribution network as following:

$$\{ \begin{matrix}{m}_{ij} = ( 1 - {z}_{ij} ) \cdot M \\ {U}_{i} - {U}_{j} \leq {m}_{ij} + 2 ( {p}_{ij} {r}_{ij} + {q}_{ij} {x}_{ij} ) \\ {U}_{j} - {U}_{i} \geq {m}_{ij} - 2 ( {p}_{ij} {r}_{ij} + {q}_{ij} {x}_{ij} ) \\ ∀ ij ∈ {Φ}_{l}\end{matrix} , \qquad ( 6 )$$

wherein, for each branch ij belonging to Φₗ, Uᵢ is squared voltage magnitude at bus i and Uⱼ is squared voltage magnitude at bus j; rᵢⱼ is resistance of branch ij; xᵢⱼ is reactance of branch ij; M ranges from 100˜10000;

7) setting power balance constraint of buses in the connected area of the active distribution network as following:

$$\{ \begin{matrix}{\sum }_{j \text{:} ( ij ) ∈ {Φ}_{l}} {p}_{ji} = {\tilde{P}}_{i} \\ {\sum }_{j \text{:} ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} , ∀ i ∈ {Ψ}_{con}\end{matrix} , \qquad ( 7 )$$

wherein, for each load demand bus i belonging to Ψ_{con} in the connected area, Qᵢ⁰ is known current reactive load demand at the load demand bus i; j:(ij)εΦₗ is set of all branches which are connected to bus i; pⱼᵢ is active power flow from bus j to bus i; qⱼᵢ is reactive power flow from bus j to bus i; δ is equal to 0.01 kW;

8) setting power balance constraint of buses in the outage area of the active distribution network as following:

$$\{ \begin{matrix}{\sum }_{j \text{:} ( ij ) ∈ {Φ}_{l}} {p}_{ji} = {\tilde{P}}_{i} \\ {\sum }_{j \text{:} ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} \leq {P}_{i}^{0} , ∀ i ∈ {Ψ}_{out}\end{matrix} ; \qquad ( 8 )$$

9) setting power balance constraint of distribution generation buses in the active distribution network as following:

$$\{ \begin{matrix}{\sum }_{j \text{:} ( ij ) ∈ {Φ}_{l}} {p}_{ji} = ( {P}_{i}^{0 , dg} / {Q}_{i}^{0 , dg} ) \cdot {\sum }_{j \text{:} ( ij ) ∈ {Φ}_{l}} {q}_{ji} \\ - {\tilde{P}}_{i}^{dg} \leq {\sum }_{j \text{:} ( ij ) ∈ {Φ}_{l}} {p}_{ji} \leq - δ , ∀ i ∈ {Ψ}_{dg}\end{matrix} , \qquad ( 9 )$$

wherein, for each distribution generation bus i belonging to Ψ_{dg}, Qᵢ^{0,dg} is known current reactive distribution generation output at the distribution generation bus i;

10) introducing auxiliary variables αᵢ⁺ and αᵢ⁻, and parameterizing uncertainty sets II in the step 1) as the following expression:

$${Π}^{′} = \{ \begin{matrix}{\tilde{P}}_{i} = {P}_{i}^{0} + {α}_{i}^{+} \overline{{\hat{P}}_{i}} - {α}_{i}^{-} \underline{{\hat{P}}_{i}} \\ {\tilde{P}}_{i}^{dg} = {P}_{i}^{0 , dg} + {α}_{i}^{+} {\overline{\hat{P}}}_{i}^{dg} - {α}_{i}^{-} {\underline{\hat{{P}_{i}}}}^{dg} \\ {α}_{i}^{+} ∈ [ 0 , 1 ] , {α}_{i}^{-} ∈ [ 0 , 1 ] \\ ∀ i ∈ \{ {Ψ}_{con} , {Ψ}_{dg} \}\end{matrix} , \qquad ( 10 )$$

and adding another constraint to control uncertainty budget as following:

$${\sum }_{i ∈ \{ {Ψ}_{con} , {Ψ}_{dg} \}} ( {α}_{i}^{+} + {α}_{i}^{-} ) \leq N , \qquad ( 11 )$$

wherein, for each fluctuation bus i belonging to Ψ_{con} or Ψ_{dg}, αᵢ⁺ and αᵢ⁻ are normalized variables, describing the upward or downward degree of deviation from accepted values ranging from [0,1]; N is a parameter denoting the uncertainty budget of the robust restoration optimization model and is a positive integer or equal to zero;

11) using a column-and-constraint generation algorithm with the constraints in step 3) to step 9), and the polyhedral uncertainty sets in step 1) and the uncertainty budget in step 10) to solve the formulation of the robust restoration optimization model in step 2); dividing the robust restoration optimization model into a master problem and a sub problem according to the solving steps of the column-and-constraint generation algorithm, and solving the sub problem and the master problem iteratively until the upper bound corresponding to the master problem and the lower bound corresponding to the sub problem are converged to obtain optimal switching decisions vector z; restoring power of the outage area of the active distribution network according to the optimal switching decisions vector z.

Advantages of the robust restoration method follow:

1. The robust restoration method of the present disclosure consider uncertainty risks of restoration control brought by the fluctuation of distribution generation outputs and load demands and estimation errors of loads. The robust restoration method of the present disclosure can ensure the feasibility and reliability of the restoration strategies generated by the method under the fluctuation of distribution generation outputs and load demands.

2. By changing value of N, conservativeness of the robust restoration optimization model can be controlled, which result in balancing the robustness and the conservativeness.

3. Modeling of the robust restoration method of the present disclosure is simple. When in use, uncertainty of load demands and distribution generation outputs are obtained based on historical data. This can improve practicability of the robust restoration method.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

A robust restoration method for an active distribution network, which considers uncertainties of load demands and distribution generation outputs in the active distribution network, according to an embodiment of the present disclosure, includes steps of:

1) after detection and isolation of faults in the active distribution network, creating polyhedral uncertainty sets II according to historical data, current load demands and distribution generation outputs of the active distribution network,

$$Π = \{ \begin{matrix}{\tilde{P}}_{i} ∈ [ {P}_{i}^{0} - \underline{{\hat{P}}_{i}} , {P}_{i}^{0} + \overline{{\hat{P}}_{i}} ] , ∀ i ∈ {Ψ}_{con} \\ {\tilde{P}}_{i}^{dg} ∈ [ {P}_{i}^{0 , dg} - {\underline{{\hat{P}}_{i}}}^{dg} , {P}_{i}^{0 , dg} + {\overline{\hat{P}}}_{i}^{dg} ] , ∀ i ∈ {Ψ}_{dg}\end{matrix} . \qquad ( 1 )$$

Ψ_{con} is set of buses in a connected area of the active distribution network, for each load demand bus i belonging to Ψ_{con} in the connected area, \tilde{P}ᵢ is actual active load demand at the load demand bus i during a restoration period, Pᵢ⁰ is known current active load demand at the load demand bus i, \hat{P}ᵢ and \hat{P̅}ᵢ are the lower limit and the upper limit of active load demand at the load demand bus i during the restoration period and range from [0, 0.5Pᵢ⁰] respectively; Ψ_{dg} is set of buses connected with distributed generations in the active distribution network; for each distribution generation bus i belonging to Ψ_{dg}, \tilde{P}ᵢ^{dg} is actual active distribution generation output at the distribution generation bus i during the restoration period, Pᵢ^{0,dg} is known current active distribution generation output at the distribution generation bus i, \hat{P}ᵢ^{dg} and \hat{P̅}ᵢ^{dg} are the lower limit and the upper limit of active distribution generation output at the distribution generation bus i and range from [0, 0.5Pᵢ^{0,dg}] respectively.

2) presenting formulation of a two-stage robust restoration optimization model as following:

$${Max}_{z ∈ Ω} [ {Min}_{p ∈ Π} ( Max {\sum }_{i ∈ {Ψ}_{out}} {\tilde{P}}_{i} ) ] . \qquad ( 2 )$$

Ψₒᵤₜ is set of buses in an outage area of the active distribution network; p is a vector of uncertain variables subject to the uncertainty sets II, involving uncertain distribution generation outputs of \tilde{P}ᵢ^{dg} and uncertain load demands of \tilde{P}ᵢ, and order of elements in the vector p ascends according to the number of the bus i; z is a vector of switching decisions in each branch of the active distribution network, and each element in the vector z is equal to zero or one, the element being equal to zero indicates a corresponding branch switch is open, the element being equal to one indicates the corresponding branch switch is closed; Ω denotes feasible region of the vector z.

$$Max {\sum }_{i ∈ {Ψ}_{out}} {\tilde{P}}_{i}$$

represents maximizing the restored power in the outage area,

$${Min}_{p ∈ Π}$$

( ) represents searching for the worst-case fluctuation scenarios across the uncertainty sets Π with the vector p regarded as decision variables to restore as much outage load as possible;

$${Max}_{z ∈ Ω}$$

[ ] represents generating optimal restoration strategies in the worst-case fluctuation scenarios with the vector z regarded as decision variables to maximize the restored power.

3) setting radial topology structure operation constraint of the active distribution network as following:

$$\{ \begin{matrix}{\sum }_{( ij ) ∈ {Φ}_{l}} {z}_{ij} = {n}_{b} - {n}_{s} \\ {z}_{ij} ∈ \{ 0 , 1 \} , ∀ ( ij ) ∈ {Φ}_{l}\end{matrix} . \qquad ( 3 )$$

Φₗ is set of all branches in the active distribution network after isolation of the faults; for each branch ij belonging to Φₗ, zᵢⱼ is a binary status variable representing the status of branch ij, zᵢⱼ being equal to zero indicates the branch is disconnected, zᵢⱼ being equal to one indicates the branch is connected; n_{b} is the number of all buses in the active distribution network after isolation of the faults and is a known value; nₛ is the number of substation buses in the active distribution network after isolation of the faults and is a known value.

For convenient detection of the faults and relay setting, the active distribution network is required to operate radially. That is, no loops exist in the active distribution network. The expression (3) can ensure no loops existing in the active distribution network.

4) setting branch capacity constraint for each branch in the active distribution network as following:

$$\{ \begin{matrix}- {z}_{ij} \cdot {\overline{s}}_{ij} \leq {p}_{ij} \leq {z}_{ij} \cdot {\overline{s}}_{ij} \\ - {z}_{ij} \cdot {\overline{s}}_{ij} \leq {q}_{ij} \leq {z}_{ij} \cdot {\overline{s}}_{ij} \\ - \sqrt{2} {z}_{ij} \cdot {\overline{s}}_{ij} \leq {p}_{ij} + {q}_{ij} \leq \sqrt{2} {z}_{ij} \cdot {\overline{s}}_{ij} \\ - \sqrt{2} {z}_{ij} \cdot {\overline{s}}_{ij} \leq {p}_{ij} - {q}_{ij} \leq \sqrt{2} {z}_{ij} \cdot {\overline{s}}_{ij} \\ ∀ ( ij ) ∈ {Φ}_{l}\end{matrix} . \qquad ( 4 )$$

For each branch ij belonging to Φₗ, pᵢⱼ is active power flow from bus i to bus j; qᵢⱼ is reactive power flow from bus i to bus j; s̅ᵢⱼ is apparent power capacity of branch ij.

The branch in the active distribution network has a limit capacity of transmission power. The robust restoration optimization model is a mixed integer quadratic constraint programming (MIQCP) model with a two-stage objective function. To facilitate dualization in the subsequent solving process, the nonlinear model must be linearized. With the quadratic constraint linearization method, several square constraints are used to approximate the circular constraint. As a consequence of this transformation, the robust restoration optimization model becomes a mixed integer linear programming (MILP) model, as shown in the expression (4).

5) setting voltage security constraint for each bus in the active distribution network as following:

$$\{ \begin{matrix}{U}_{i} = {V}_{i}^{2} \\ {\underline{U}}_{i} \leq {U}_{i} \leq {\overline{U}}_{i} , ∀ i ∈ {Ψ}_{b}\end{matrix} . \qquad ( 5 )$$

Ψ_{b} is set of all buses in the active distribution network after isolation of the faults; for each bus i belonging to Ψ_{b}, Vᵢ is voltage magnitude at bus i; Uᵢ is squared voltage magnitude representing voltage variable; Uᵢ and Ūᵢ are the lower limit and the upper limit of the squared voltage magnitude at bus i, respectively.

6) setting power flow equality constraint for each branch in the active distribution network as following:

$$\{ \begin{matrix}{m}_{ij} = ( 1 - {z}_{ij} ) \cdot M \\ {U}_{i} = {U}_{j} \leq {m}_{ij} + 2 ( {p}_{ij} {r}_{ij} + {q}_{ij} {x}_{ij} ) \\ {U}_{j} = {U}_{i} \geq {m}_{ij} - 2 ( {p}_{ij} {r}_{ij} + {q}_{ij} {x}_{ij} ) \\ ∀ ij ∈ {Φ}_{l}\end{matrix} . \qquad ( 6 )$$

For each branch ij belonging to Φₗ, Uᵢ is squared voltage magnitude at bus i and Uⱼ is squared voltage magnitude at bus j; rᵢⱼ is resistance of branch ij; xᵢⱼ is reactance of branch ij; M is a large positive number and ranges from 100˜10000.

The expression (6) describes the power flow expressions, where power loss in branches is ignored. The M is introduced to cancel the constraints in disconnected branches.

7) setting power balance constraint of buses in the connected area of the active distribution network as following:

$$\{ \begin{matrix}{\sum }_{j : ( ij ) ∈ {Φ}_{l}} {p}_{ji} = {\tilde{P}}_{i} \\ {\sum }_{j : ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} , ∀ i ∈ {Ψ}_{con}\end{matrix} . \qquad ( 7 )$$

For each load demand bus i belonging to Ψ_{con} in the connected area, Qᵢ⁰ is known current reactive load demand at the load demand bus i; j:(ij)εΦₗ is set of all branches which are connected to bus i; pⱼᵢ is active power flow from bus j to bus i; qⱼᵢ is reactive power flow from bus j to bus i; δ is a small positive number and is equal to 0.01 kW.

The expression (7) represents the power balance constraint of buses in the connected area of the active distribution network. In the expression (7), the power factors of load demands are presumed to be varied during the restoration period. The inequalities corresponding to δ aim to avoid the existence of transfer buses with no generation or load in the solutions.

8) setting power balance constraint of buses in the outage area of the active distribution network as following:

$$\{ \begin{matrix}{\sum }_{j : ( ij ) ∈ {Φ}_{l}} {p}_{ji} = {\tilde{P}}_{i} \\ {\sum }_{j : ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} \leq P , ∀ i ∈ {Ψ}_{out}\end{matrix} . \qquad ( 8 )$$

The expression (8) represents the power balance constraint of buses in the outage area of the active distribution network. In the expression (8), the power factors of load demands are presumed to be fixed during the restoration period.

9) setting power balance constraint of distribution generation buses in the active distribution network as following:

$$\{ \begin{matrix}{\sum }_{j : ( ij ) ∈ {Φ}_{l}} {p}_{ji} = ( {P}_{i}^{0 , dg} / {Q}_{i}^{0 , dg} ) \cdot {\sum }_{j : ( ij ) ∈ {Φ}_{l}} {q}_{ji} \\ - {\tilde{P}}_{i}^{dg} \leq {\sum }_{j : ( ij ) ∈ {Φ}_{l}} {p}_{ji} \leq - δ , ∀ i ∈ {Ψ}_{dg}\end{matrix} . \qquad ( 9 )$$

For each distribution generation bus i belonging to Ψ_{dg}, Qᵢ^{0,dg} is known current reactive distribution generation output at the distribution generation bus i.

The expression (9) represents the power balance constraint of distribution generation buses in the active distribution network. In the expression (9), the power factors of distribution generation outputs are presumed to be fixed during the restoration period.

10) introducing auxiliary variables αᵢ⁺ and αᵢ⁻, and parameterizing uncertainty sets II in the step 1) as the following expression:

$${Π}^{′} = \{ \begin{matrix}{\tilde{P}}_{i} = {P}_{i}^{0} + {α}_{i}^{+} \overline{{\hat{P}}_{i}} - {α}_{i}^{-} \underline{{\hat{P}}_{i}} \\ {\tilde{P}}_{i}^{dg} = {P}_{i}^{0 , dg} + {α}_{i}^{+} {\overline{\hat{P}}}_{i}^{dg} - {α}_{i}^{-} {\underline{\hat{{P}_{i}}}}^{dg} \\ {α}_{i}^{+} ∈ [ 0 , 1 ] , {α}_{i}^{-} ∈ [ 0 , 1 ] \\ ∀ i ∈ \{ {Ψ}_{con} , {Ψ}_{dg} \}\end{matrix} , \qquad ( 10 )$$

and adding another constraint to control uncertainty budget as following:

$${\sum }_{i ∈ \{ {Ψ}_{con} , {Ψ}_{dg} \}} ( {α}_{i}^{+} + {α}_{i}^{-} ) \leq N . \qquad ( 11 )$$

For each fluctuation bus i belonging to Ψ_{con} or Ψ_{dg}, αᵢ⁺ and αᵢ⁻ are normalized variables, describing the upward or downward degree of deviation from accepted values ranging from [0, 1]; N is a parameter denoting the uncertainty budget of the robust restoration optimization model and is a positive integer or equal to zero.

The parameterized uncertainty sets II′ in the expression (10) is the parameterization form of the uncertainty sets II in the expression (1). By changing values of αᵢ⁺ and αᵢ⁻, \tilde{P}ᵢ and \tilde{P}ᵢ^{dg} can be equal to any values in the uncertain ranges. The expression (11) represents the uncertainty budget constraint. By changing value of N, value ranges of αᵢ⁺ and αᵢ⁻ can be controlled to balance the robustness and conservativeness.

11) using a column-and-constraint generation algorithm with the constraints in step 3) to step 9), and the polyhedral uncertainty sets in step 1) and the uncertainty budget in step 10) to solve the formulation of the robust restoration optimization model in step 2); dividing the robust restoration optimization model into a master problem and a sub problem according to the solving steps of the column-and-constraint generation algorithm, and solving the sub problem and the master problem iteratively until the upper bound corresponding to the master problem and the lower bound corresponding to the sub problem are converged to obtain optimal switching decisions vector z; restoring power of the outage area of the active distribution network according to the optimal switching decisions vector z.

Advantages of the robust restoration method follow:

1. The robust restoration method of the present disclosure consider uncertainty risks of restoration control brought by the fluctuation of distribution generation outputs and load demands and estimation errors of loads. The robust restoration method of the present disclosure can ensure the feasibility and reliability of the restoration strategies generated by the method under the fluctuation of distribution generation outputs and load demands.

2. By changing value of N, conservativeness of the robust restoration optimization model can be controlled, which result in balancing the robustness and the conservativeness.

3. Modeling of the robust restoration method of the present disclosure is simple. When in use, uncertainty of load demands and distribution generation outputs are obtained based on historical data. This can improve practicability of the robust restoration method.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. A robust restoration method for an active distribution network, comprising steps of:
1) after detection and isolation of faults in the active distribution network, creating polyhedral uncertainty sets II according to historical data, current load demands and distribution generation outputs of the active distribution network, wherein
$$Π = \{ \begin{matrix}{\tilde{P}}_{i} ∈ [ {P}_{i}^{0} - \underline{{\hat{P}}_{i}} , {P}_{i}^{0} + \overline{{\hat{P}}_{i}} ] , ∀ i ∈ {Ψ}_{con} \\ {\tilde{P}}_{i}^{dg} ∈ [ {P}_{i}^{0 , dg} - {\underline{{\hat{P}}_{i}}}^{dg} , {P}_{i}^{0 , dg} + {\overline{\hat{P}}}_{i}^{dg} ] , ∀ i ∈ {Ψ}_{dg}\end{matrix} , \qquad ( 1 )$$
Ψ_{con} is set of buses in a connected area of the active distribution network, for each load demand bus i belonging to Ψ_{con} in the connected area, \tilde{P}ᵢ is actual active load demand at the load demand bus i during a restoration period, Pᵢ⁰ is known current active load demand at the load demand bus i, \hat{P}ᵢ and \hat{P̅}are the lower limit and the upper limit of active load demand at the load demand bus i during the restoration period and range from [0, 0.5Pᵢ⁰] respectively; Ψ_{dg} is set of buses connected with distributed generations in the active distribution network; for each distribution generation bus i belonging to Ψ_{dg}, \tilde{P}ᵢ^{dg} is actual active distribution generation output at the distribution generation bus i during the restoration period, Pᵢ^{0,dg} is known current active distribution generation output at the distribution generation bus i, \hat{P}ᵢ^{dg} and \hat{P̅}ᵢ^{dg} are the lower limit and the upper limit of active distribution generation output at the distribution generation bus i and range from [0, 0.5Pᵢ^{0,dg}] respectively;
2) presenting formulation of a two-stage robust restoration optimization model as following:
$${Max}_{z ∈ Ω} [ {Min}_{p ∈ Π} ( Max {\sum }_{i ∈ {Ψ}_{out}} {\tilde{P}}_{i} ) ] , \qquad ( 2 )$$
wherein, Ψₒᵤₜ is set of buses in an outage area of the active distribution network; p is a vector of uncertain variables subject to the uncertainty sets II, involving uncertain distribution generation outputs of \tilde{P}ᵢ^{dg} and uncertain load demands of \tilde{P}ᵢ, and order of elements in the vector p ascends according to the number of the bus i; z is a vector of switching decisions in each branch of the active distribution network, and each element in the vector z is equal to zero or one, the element being equal to zero indicates a corresponding branch switch is open, the element being equal to one indicates the corresponding branch switch is closed; Ω denotes feasible region of the vector z;
$$Max {\sum }_{i ∈ {Ψ}_{out}} {\tilde{P}}_{i}$$
represents maximizing the restored power in the outage area,
$${Min}_{p ∈ Π}$$
( ) represents searching for the worst-case fluctuation scenarios across the uncertainty sets Π with the vector p regarded as decision variables to restore as much outage load as possible;
$${Max}_{z ∈ Ω}$$
[ ] represents generating optimal restoration strategies in the worst-case fluctuation scenarios with the vector z regarded as decision variables to maximize the restored power;
3) setting radial topology structure operation constraint of the active distribution network as following:
$$\{ \begin{matrix}{\sum }_{( ij ) ∈ {Φ}_{l}} {z}_{ij} = {n}_{b} - {n}_{s} \\ {z}_{ij} ∈ \{ 0 , 1 \} , ∀ ( ij ) ∈ {Φ}_{l}\end{matrix} , \qquad ( 3 )$$
wherein, Φᵢ is set of all branches in the active distribution network after isolation of the faults; for each branch ij belonging to Φₗ, zᵢⱼ is a binary status variable representing the status of branch ij, zᵢⱼ being equal to zero indicates the branch is disconnected, zᵢⱼ being equal to one indicates the branch is connected; n_{b} is the number of all buses in the active distribution network after isolation of the faults and is a known value; nₛ is the number of substation buses in the active distribution network after isolation of the faults and is a known value;
4) setting branch capacity constraint for each branch in the active distribution network as following:
$$\{ \begin{matrix}- {z}_{ij} \cdot {\overline{s}}_{ij} \leq {p}_{ij} \leq {z}_{ij} \cdot {\overline{s}}_{ij} \\ - {z}_{ij} \cdot {\overline{s}}_{ij} \leq {p}_{ij} \leq {z}_{ij} \cdot {\overline{s}}_{ij} \\ - \sqrt{2} {z}_{ij} \cdot {\overline{s}}_{ij} \leq {p}_{ij} + {q}_{ij} \leq \sqrt{2} {z}_{ij} \cdot {\overline{s}}_{ij} \\ - \sqrt{2} {z}_{ij} \cdot {\overline{s}}_{ij} \leq {p}_{ij} - {q}_{ij} \leq \sqrt{2} {z}_{ij} \cdot {\overline{s}}_{ij} \\ ∀ ( ij ) ∈ {Φ}_{l}\end{matrix} , \qquad ( 4 )$$
wherein, for each branch ij belonging to Φₗ, pᵢⱼ is active power flow from bus i to bus j; qᵢⱼ is reactive power flow from bus i to bus j; s̅ᵢⱼ is apparent power capacity of branch ij;
5) setting voltage security constraint for each bus in the active distribution network as following:
$$\{ \begin{matrix}{U}_{i} = {V}_{i}^{2} \\ {\underline{U}}_{i} \leq {U}_{i} \leq {\overline{U}}_{i} , ∀ i ∈ {Ψ}_{b}\end{matrix} , \qquad ( 5 )$$
wherein, Ψ_{b} is set of all buses in the active distribution network after isolation of the faults; for each bus i belonging to Ψ_{b}, Vᵢ is voltage magnitude at bus i; Uᵢ is squared voltage magnitude representing voltage variable; Uᵢ and Ūᵢ are the lower limit and the upper limit of the squared voltage magnitude at bus i, respectively;
6) setting power flow equality constraint for each branch in the active distribution network as following:
$$\{ \begin{matrix}{m}_{ij} = ( 1 - {z}_{ij} ) \cdot M \\ {U}_{i} - {U}_{j} \leq {m}_{ij} + 2 ( {p}_{ij} {r}_{ij} + {q}_{ij} {x}_{ij} ) \\ {U}_{j} - {U}_{i} \geq {m}_{ij} - 2 ( {p}_{ij} {r}_{ij} + {q}_{ij} {x}_{ij} ) \\ ∀ ij ∈ {Φ}_{l}\end{matrix} , \qquad ( 6 )$$
wherein, for each branch ij belonging to Φₗ, Uᵢ is squared voltage magnitude at bus i and Uⱼ is squared voltage magnitude at bus j; rᵢⱼ is resistance of branch ij; xᵢⱼ is reactance of branch ij; M ranges from 100˜10000;
7) setting power balance constraint of buses in the connected area of the active distribution network as following:
$$\{ \begin{matrix}{\sum }_{j : ( ij ) ∈ {Φ}_{l}} {p}_{ji} = {\tilde{P}}_{i} \\ {\sum }_{j : ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} , ∀ i ∈ {Ψ}_{con}\end{matrix} , \qquad ( 7 )$$
wherein, for each load demand bus i belonging to Ψ_{con} in the connected area, Qᵢ⁰ is known current reactive load demand at the load demand bus i; j:(ij)εΦₗ is set of all branches which are connected to bus i; pⱼᵢ is active power flow from bus j to bus i; qⱼᵢ is reactive power flow from bus j to bus i; δ is equal to 0.01 kW;
8) setting power balance constraint of buses in the outage area of the active distribution network as following:
$$\{ \begin{matrix}{\sum }_{j : ( ij ) ∈ {Φ}_{l}} {p}_{ji} = {\tilde{P}}_{i} \\ {\sum }_{j : ( ij ) ∈ {Φ}_{l}} {q}_{ji} = ( {Q}_{i}^{0} / {P}_{i}^{0} ) \cdot {\tilde{P}}_{i} \\ δ \leq {\tilde{P}}_{i} \leq {P}_{i}^{0} , ∀ i ∈ {Ψ}_{out}\end{matrix} ; \qquad ( 8 )$$
9) setting power balance constraint of distribution generation buses in the active distribution network as following:
$$\{ \begin{matrix}{\sum }_{j : ( ij ) ∈ {Φ}_{l}} {p}_{ji} = ( {P}_{i}^{0 , dg} / {Q}_{i}^{0 , dg} ) \cdot {\sum }_{j : ( ij ) ∈ {Φ}_{l}} {q}_{ji} \\ - {\tilde{P}}_{i}^{dg} \leq {\sum }_{j : ( ij ) ∈ {Φ}_{l}} {p}_{ji} \leq - δ , ∀ i ∈ {Ψ}_{dg}\end{matrix} , \qquad ( 9 )$$
wherein, for each distribution generation bus i belonging to Ψ_{dg}, Qᵢ^{0,dg} is known current reactive distribution generation output at the distribution generation bus i;
10) introducing auxiliary variables αᵢ⁺ and αᵢ⁻, and parameterizing uncertainty sets II in the step 1) as the following expression:
$${Π}^{′} = \{ \begin{matrix}{\tilde{P}}_{i} = {P}_{i}^{0} + {α}_{i}^{+} \overline{{\hat{P}}_{i}} - {α}_{i}^{-} \underline{{\hat{P}}_{i}} \\ {\tilde{P}}_{i}^{dg} = {P}_{i}^{0 , dg} + {α}_{i}^{+} {\overline{\hat{P}}}_{i}^{dg} - {α}_{i}^{-} {\underline{\hat{{P}_{i}}}}^{dg} \\ {α}_{i}^{+} ∈ [ 0 , 1 ] , {α}_{i}^{-} ∈ [ 0 , 1 ] \\ ∀ i ∈ \{ {Ψ}_{con} , {Ψ}_{dg} \}\end{matrix} , \qquad ( 10 )$$
and adding another constraint to control uncertainty budget as following:
$${\sum }_{i ∈ \{ {Ψ}_{con} , {Ψ}_{dg} \}} ( {α}_{i}^{+} + {α}_{i}^{-} ) \leq N , \qquad ( 11 )$$
wherein, for each fluctuation bus i belonging to Ψ_{con} or Ψ_{dg}, αᵢ⁺ and αᵢ⁻ are normalized variables, describing the upward or downward degree of deviation from accepted values ranging from [0, 1]; N is a parameter denoting the uncertainty budget of the robust restoration optimization model and is a positive integer or equal to zero;
11) using a column-and-constraint generation algorithm with the constraints in step 3) to step 9), and the polyhedral uncertainty sets in step 1) and the uncertainty budget in step 10) to solve the formulation of the robust restoration optimization model in step 2); dividing the robust restoration optimization model into a master problem and a sub problem according to the solving steps of the column-and-constraint generation algorithm, and solving the sub problem and the master problem iteratively until the upper bound corresponding to the master problem and the lower bound corresponding to the sub problem are converged to obtain optimal switching decisions vector z; restoring power of the outage area of the active distribution network according to the optimal switching decisions vector z.
